(19) United States
(12) Patent Application Publication
(10) Pub. No.: US 2008/0294663 A1
(43) Pub. Date: Nov. 27, 2008

(54) Creation and management of visual timelines

(76) Inventors: Brandon J. Heinley, Austin, TX (US); Derek Dukes, San Francisco, CA (US); Zack Steinkamp, San Jose, CA (US); Benjamin A. Garrett, San Francisco, CA (US); Ryan J. Romanchuk, Santa Clara, CA (US)

Correspondence Address: STRATEGIC PATENTS P.C.., C/O PORTFOLIOIP, P.O. BOX 52050, MINNEAPOLIS, MN, 55402, US

(21) Appl. No.: 12/152,672

(22) Filed: May 14, 2008

Related U.S. Application Data
(60) Provisional application No. 60/917,747, filed on May 14, 2007.
(60) Provisional application No. 60/980,462, filed on Oct. 17, 2007.

(51) Int. Cl. G06F 17/30; G06F 3/048

(52) U.S. Cl. 707/100; 715/764; 707/E17.009

(57) ABSTRACT

In embodiments of the present invention improved capabilities are described for the management and creation of timelines. The timelines may be automatically created based on a user query for information. The query may access a database that contains links to external information sources. The timeline may be accessed through a social network. The timeline may be automatically updated. The timeline may include visual and audio events that may provide additional information to the user.

### CROSS-REFERENCE TO RELATED APPLICATIONS

This application claims the benefit of the following provisional applications, each of which is hereby incorporated by reference in its entirety: App. No. 60/917,747 filed on May 14, 2007 and entitled “Automatic Creation of Visual Timelines,” and App. No. 60/980,462 filed on Oct. 17, 2007 and entitled “Visual Timelines for Social Networking Applications.”

### BACKGROUND

1. Field

The invention is related to creating timelines that include visual and audio event information and in particular to the automatic creation of the timelines from queried data.

2. Description of the Related Art

Timelines are often created to visually display time frame information of events or a series of events. These timelines are often created manually with information that is available to the creator of the timeline. There is a need for a method and system for the automatic creation of timelines that allows the user to query for information to be added to the timeline.

### SUMMARY

A method and system disclosed herein may include querying a database and receiving time-based information; automatically placing the time-based information as an event in a timeline, the timeline optionally providing a visual chronological view of the time-based information; associating objects with the events on the timeline, the objects optionally being any one or more of an image, an audio file, a video, a hyperlink, a map, an RSS feed, a message, and a blog; associating a plurality of the timelines into a view, the plurality of timelines optionally indicating convergences of events; and creating a social network of users interacting with the plurality of timelines.

In social networking applications, a user may display timelines for friends, and view a graphical depiction of shared objects, unshared objects (e.g., events missed by the user), and the like. A user may also display a ranked list of commonality with friends as determined according to a number of shared events or other objects. An interactive timeline may be exported for use in other contexts such as a website or electronic document.

In embodiments, a data feed generator may be provided that is adapted to generate a datafeed that is based on a specified criterion for constructing a timeline. A datafeed may be generated based on a specified criterion, and data from the datafeed may be stored in an event store. In embodiments, the datafeed generator may be associated with a user interface whereby a user may specify a user preference that is associated with a criterion. A criterion may be automatically generated and submitted to the datafeed generator based at least in part on a user behavior. A criterion may be a subject matter, a date, a keyword, a location, a demographic, a financial metric, or some other type of information. In embodiments, a user behavior may be a search query, a browse behavior, a transaction behavior, or some other type of user behavior.

In embodiments, an event store may be automatically updated based at least in part on a new datum within the datafeed. In embodiments, a datafeed may be a user-entered datum, an RSS feed, a spidered datum, a published datum, or some other type of datafeed.

In embodiments, a datafeed may be associated with social data.

In embodiments, a query may be made to an event store that stores data suitable for construction of a timeline. A timeline may be populated based at least in part on the query, and the timeline that includes the datum may be published.

In embodiments, a timeline may be populated based at least in part on a user-specified preference. In embodiments, a timeline may be populated based at least in part on a criterion developed based on user behavior.

In embodiments, a tag may be associated with a content to create a tagged-content, wherein a component of the tag is a time datum. The tagged-content may be stored in an event store, wherein the event store includes a plurality of time-tagged-content items. The event store may be queried to select time-tagged-content to be used to construct a timeline, the timeline based on a criterion indicated in the query, and the timeline based at least in part on the time-tagged-content may be published. In embodiments, the tagged content may be Internet content, user-created content, or some other type of content.

In embodiments, a user interface may be provided whereby a user may specify criteria for construction of a timeline. A storage facility may be provided by which a user-specified criterion is stored upon specification of the criterion in the user interface, and a timeline generator may be provided for generating a timeline based on the user-specified criterion. In embodiments, the timeline generator may access an event store of time-tagged content items in order to populate the timeline. In embodiments, the user may specify a criterion that is a duration for the timeline.

In embodiments, an online timeline may be provided, the online timeline displaying data associated with a time period, the data being associated with events occurring during the time period. A plurality of graphical object types may be provided, the object types representing different kinds of events, and the representation of a plurality of content items as graphical object types may be enabled, the object types being associated with times on the timeline.

In embodiments, an application programming interface may be provided, the application programming interface facilitating the generation of timelines, whereby upon an interaction with the application programming interface, an online, graphical timeline is constructed, the online graphical timeline using at least one of a user preference specified by a user in a user interface, a time-tagged event retrieved from an event store of time-tagged content items, a graphical object type adapted to represent a type of data in association with the timeline and a datafeed generator for supplying a feed of time-based data for construction of the timeline. In embodiments, the application programming interface may facilitate modification of the timeline by a plurality of users.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a schematic of the data gathering and data storing for timeline creation and display.

FIG. 2 depicts an embodiment of a datafeed generator search results page.

FIG. 3 depicts an embodiment of a typical single timeline page.

FIG. 4 depicts an embodiment of the timeline page with additional information displayed.

FIG. 5 depicts an embodiment of multiple timelines displayed on the timeline page.

FIG. 6 depicts an embodiment of timeline event convergence.

FIG. 7 depicts an embodiment of a timeline associated with public information.

FIG. 8 shows a timeline for use in a social network.

FIG. 9 shows common events shared by a number of users in a social network.

FIG. 10 shows a single view of timelines for a number of social network friends.

FIG. 11 depicts a simplified user interface for adding or removing feeds from a timeline.

FIG. 12 depicts a generalized method for using a datafeed generator to populate an event store.

FIG. 13 depicts a generalized method for querying an event store and creating a timeline.

FIG. 14 depicts a generalized method for associating time tags with content for the purpose of creating and publishing a timeline.

FIG. 15 depicts a generalized method for providing a user interface with which a user may specify criteria to be used in constructing a timeline.

FIG. 16 depicts a generalized method for providing user interface elements in association with the construction and management of a timeline.

FIG. 17 depicts a generalized method for providing an application programming interface in association with the construction and management of a timeline.

### DETAILED DESCRIPTION

Events (past, current, and future) may be visualized and understood when presented in a timeline providing the aspect of time sequencing to the various events. The events may be personal events such as important dates to a person for a calendar year (e.g. birthdays and anniversaries), professional events such as meetings or project end dates, historical events such as political or entertainment milestones of past years, fictional events such as the plot of a novel or movie, hypothetical events such as the hypothetical occurrences resulting from the non-occurrence of a real event (e.g., quarterly government expenditures if a military endeavor had not occurred), future events, such as planned events, or any of a wide range of other events, occurrences, phenomena that a user may want to track or explore. The user may view timelines to ensure that important dates are not missed, view events that may be important or milestones of past, present or future times, or view events that may be happening in the current time space for various topics (e.g. entertainment, politics, weather), occurring in the future, or blended elements incorporating past, present and future events. Timelines may be depictions of fictional events, phenomena, storylines, and the like, and may blend fictional and actual events.

In embodiments, a user's personal timeline may be temporally synchronized with a plurality of other timelines in order to place the events of his life in temporal juxtaposition with the larger world of events.

In embodiments the user may be able to construct a timeline using personal data, public data (e.g. web or RSS feeds), published data (e.g. newspapers), contributed third party information, or the like. Discovery services may be used in order to build a timeline content index that may be used, in part, for constructing a timeline or plurality of timelines. This index may be populated by means of an explicit data feed of content elements or by spidering a Web or some other site containing the metadata about the content Timeline content and metadata may also be obtained from a user's computer, an intranet, or some other electronic data facility. A data feed may be provided with a regularly scheduled transfer of data, or unscheduled transfer of data Feeds may consist of content, taxonomy, an image, an audio file, a video, a hyperlink, an RSS feed, a message, a location, a blog, or some other form of electronic data. Content may include metadata about a plurality of timelines. For example, a date datum may be associated with metadata about multiple events, facts, or phenomena, real and fictional, relating to that date, such as “1984” relating to both “Ronald Reagan,” the former United States President, and “Julia,” the fictional character in George Orwell's novel “1984.” In another example, a digital photograph of the Brooklyn Bridge may be associated with metadata relating to construction methods, New York City history, worker safety, architectural design, or some other fact, event, or phenomenon. Taxonomy may include a description of the categorization system used for the data elements. Content and taxonomy data may be distributed separately, or they may be intermingled into one data file. From this metadata a timeline may be built. Data feeds may be scheduled to run at predefined times or may be triggered upon request. The timeline may be developed over time where there may be an initial setup containing some events and other events may be added as the user may determine that the information should be included in the timeline. The user may also be able to view more than one timeline at a time. This may allow the user to look at different events that may have occurred at the same time (convergence), have similar chain of events, or the like. Once constructed any timeline as disclosed herein may be made public, kept private, or made partially public and partially private, using password systems, conditional access methods and systems and other hardware or software-based privacy and security systems.

Additionally, the user may be able to combine a plurality of timelines into a single view so the interrelations of the plurality of timelines can be reviewed and explored. For example, the user may have a personal timeline with calendar information from the user's life and may add timelines from websites containing the user's images, blog information, family members, friends, world events, and the like. With the combined timelines, the user may be able to easily find information related to an event in which the user is interested. For example, the user may want to find information on a dinner party that other people attended and the user has access to their timelines. The user could go back in time on the other people's timelines to get information such as the names of the people that attended the party, photos taken during the party, the name of the restaurant at which the party was held, and the like. In this manner, the combined timelines may become a social network where different users may be able to share information in a time ordered visual way. In embodiments, a user may be able to choose which of the timelines or portions of timelines he wants to make publicly available. A user may make a timeline completely public or completely private, partially public or partially private. A user may choose to make a subset of timelines completely public, and another subset of timelines completely private, and so forth. A user may be able to extend invitations to persons to whom he chooses to grant timeline access. In making timelines or portions of timelines publicly available, a user may be able to select individuals, groups, or some other subset of the general public to whom to give access to the timeline information.

In an example, a user may construct a personal timeline covering their life from birth to their current age. In addition to the text describing various events occurring throughout their life, the user may place photographs and additional text commentary associated with each event The user may choose to grant access to the general public for the timeline's text description of events, but to limit access to the photographs associated with the events to a subset of the public (e.g., friends only). Furthermore, the user may choose to grant access to his commentary on the photos to only a subset of the friends having access rights to the photographs (e.g., close friends only). In another example, a user may construct a timeline of a product roll-out schedule for a product that is currently in development at the user's startup. Rather than provide details of the product and its scheduling to the general public, which may include competitors, the user may choose to limit access to the timeline to only those persons who are permitted by the corporation to be privy to such matters. As certain milestones in the product's development are met, the user may choose to “release” portions of the timeline to the general public as a form of press release. A timeline press release such as this may provide useful information to the public, such as how long it has taken the company to reach the milestone, how the milestone maps onto the company's financing, how the milestone compares to competitor's timelines, how the time to this milestone compares to the time required for the company to meet past milestones, or some other information. In another example, a parent may keep a timeline of their child's daily activities and food intake for the purpose of keeping a daily diary to determine food-allergy associations. The parent may selectively grant access to this timeline to only the child's healthcare providers. Upon the child changing or adding healthcare providers, the parent may remove the access privileges to the child's timeline to a healthcare provider that is no longer caring for the child, and/or add access rights for new healthcare providers.

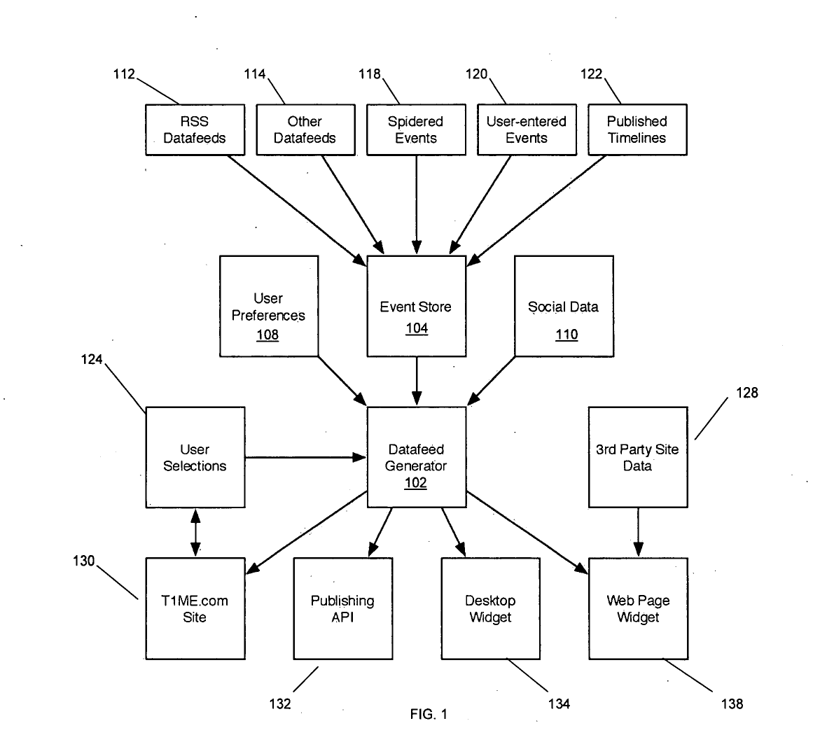

Referring to FIG. 1, a schematic of the data gathering and data storing for timeline creation and display is shown. Timeline data may be received from a plurality of data sources and locations such as RSS datafeeds 112, other datafeeds 114, spidered events 118, user entered events 120, published events 122, or the like. These various data inputs may be input and stored within an event store 104 for retrieval by a user for the creation of a timeline.

In an embodiment, the event store 104 may be a database or set of databases for storing the information from the plurality of data locations. In embodiments, there may be a single database that stores the information, there may be a related set of databases for storing the information, there may be a plurality of individual databases for storing the various information, or other database structure that is capable of storing the information from the plurality of data locations. In an embodiment, the database may be a table, a relation database, a flat file, an XML file, or some other electronic data format or data storage protocol.

In an embodiment, the event store 104 may periodically query the various data locations for information or information may be continually fed to the event store 104 such as from the RSS data feed 112. The time frame for the periodic queries may be adjustable and may be set to look for new information at various times of the day, at various times over a week, at various times over a month, or the like. The query time may be established based on the type of data location that is providing information to the event store 104. For example, an RSS datafeed 112 may be queried several times a day while a published timeline 122 may be queried once a day. The information gathered from the data locations may include time information such as time stamps that may provide the time information needed to chronologically store the information in the event store 104. If the information from the data locations does not contain time information, the event store 104 may apply a time stamp on the information as it is received to allow the chronological storing of information.

Once information has been gathered from the data locations into the event store 104, a datafeed generator 102 may be used to query the event store 104 for data to be input into a timeline. The datafeed generator 102 may also receive inputs from the user that are related to user preferences 108, social data 110, or some other information type. The user preferences 124 may provide user preference requirements such as particular data information of interest, the presentation of the timeline such as colors and displayed time lengths, or the like.

The social data 110 may be information and timelines from other sources that, when combined with the user's timeline, may provide social interaction for the user. For example, the user may create a multiple timeline page that may contain the user's personal timeline and the timelines of the user's friends and family. The friends and family may also have access to the user's timeline in their timeline pages. The sharing of timelines among users may form a social network that may allow the different users to access the information from all of the different timelines. The user may be able to interact with the other timelines within the user's timeline page and access information such as images, audio files, video, maps, and the like from the friends and family timelines. This social networking may be a method of aggregating the world of the user into one easy to view set of visual timelines. The world of the user may be the user's information and information of other users that is scattered across various computer locations on small and large networks that can be combined into a set of timelines. The timelines in the user's timeline page may be able to bring together, into one simple display, many aspects of the user's life and may enable viewing by the user and other users that have access to the user's timelines. As another example, the user may have missed a family gathering, but if a family member who attends the gathering posted pictures on a website that is linked to the family member's timeline, the user may be able to view the images by looking at the family gathering event and viewing the images. Additionally, the family gathering event may be indicated as a convergence date across all the timelines and the user may easily see the common information for all the timelines on the user's timeline page.

In embodiments, webpages may be associated with events on a timeline. Webpages may be tagged so that the final page in a series associated with a particular part of a timeline, such as an event on a timeline, is a “leaf” page—a last page onto which a user drills by clicking through a series or hierarchy of pages associated with the event.

In creating a timeline, the user may provide user selections 124 for the information the user may wish to display on the timeline. In embodiments, the user may be able to indicate the number of timelines to create, the category of the timeline(s), the timeframe of the timeline(s), or the like. For example, a user may wish to view various history milestones related to the user's personal history. The user may request that the user's personal timeline be displayed and also display a historical timeline. The user may be able to indicate to the datafeed generator 102 the type of historical events that are of interest such as political, entertainment, enterprise, or the like. The user may also request that any points of convergence, where events of the different timelines happen at the same time, be displayed; the convergence points may provide a visual history of the events that were happening at the same time as some of the user's personal events. The convergence points do not need to be of a common subject, but just occur at the same time. The convergence provides a visual indication that more than one event occurred at the same time and may allow the user to view information from the various subjects on the same or different timelines.

In embodiments, the user may input information into timelines by requesting information from the datafeed generator 102, directly inputting information, using information templates, adding tags to various external inputs, or the like. The user may use a combination of information sources to create the timeline. For example, the user may begin by inputting information that the user may already have in data files, books, magazines, personal information stores, or the like. Once the initial timeline is established, the user may add more information from the datafeed generator 102 that may have access to the plurality of data locations. Additionally, the user may be able to add additional tags (timetagging) to electronic data (e.g. RSS feeds, webpages) that may have information the user wishes to have in the timeline. In an embodiment, the timeline may be created directly from information from the datafeed generator 102.

Timetagging may be the process of adding chronological identification metadata to various media such as websites, RSS feeds, timelines, or images. This data may consist of years, months, weeks, days, hours, minutes, and seconds. The data may also include identifying names. Timecoding also refers to the process of taking non-chronological-based date identifiers, such as range of events, and converting them into chronological parameters. Timetagging can help users find a wide variety of time-specific information. For example, one can find images taken around a given time by entering a date and time into a timetag-enabled image search engine. Timetag-enabled information services can also potentially be used to find news, websites, or other resources.

In embodiments, the timeline may include time information, location information, image information, audio information, video information, text information, or some other type of information. In embodiments, the user may be able to input personal information from a plurality of informational sources such as a camera, a phone, an iPod, an iPhone, a browser bar button, a calendar (e.g. iCal, Google, Yahoo!), a website, a blog, a phone call, a text message, Twitter, video games (e.g. Wii, Xbox 360), TIVO, a RSS feed, a news site, a image site, or some other source. The user may determine where the information is to be placed within the timeline by setting a date/time to place it, manually placing it on the timeline, using data from within the information to place the information on the timeline, or the like.

The user may be able to input information from the datafeed generator 102 or other tagged data sources. In an embodiment, the user may request information that is related to an existing time line or may request information to be displayed on an additional timeline. For example, the user may create or view a first timeline for a United States president and then create or view a second timeline for world events during the president's years in office. By displaying the two timelines, the user may be able to explore the relationships between the actions of the president and the world events during the president's time in office.

In an embodiment, the timelines may be static or may be dynamic. For example, a static timeline may be a historical timeline that provides information for past events. A dynamic timeline may be a personal timeline that may have past, present, and future events (e.g. birthdays, meetings) on the timeline. The dynamic timelines may be tracked to the current time, to a time indicated by the user, or the like. The user may be able to use templates that may be recalled from a stored location such as the datafeed generator 102 or the event store 104 and may apply the templates to the timeline. Templates may be a way to set up and apply predetermined actions when an event occurs. For example, in a birthday template, the user's friends may be notified two weeks before your birthday and they may be sent your birthday wish list, a reminder may be sent to your family to make reservations for dinner, and after the birthday, an email may be sent out to your friends to upload photos of the birthday celebration, and the birthday person may be sent an email reminding the user to thank the friends for the gifts. Templates may be stored and recalled in the datafeed generator 102 or may be created, exchanged, and adopted by users. Templates may be set up for any of the timelines that are available on the user's timeline page. For example, the user may use a template on a parent's timeline to provide reminders to call the parents on their anniversary, send flowers to the user's mother, and set up a golf date with the user's father.

In addition to applying events to the timeline, the user may be able to indicate the importance of the event. The importance or significance of an event may be a rating relative to other events on the timeline and may provide input as to the placement of the event on the timeline. In embodiments, the rating may be a number scale, numeric summary, letter scale, a star rating, or the like to indicate the significance of one event to another. Ratings may consist of an individual's ratings or group ratings. Ratings may be aggregated, summed, averaged, weighted or mathematically manipulated prior to presenting to a user. A user may be able to select the type of mathematical manipulation to perform on the ratings he is presented (e.g., “show average rating where each rating is weighted by one's age decile, where my age decile has the largest weight”). In embodiments, a user may be able to specify an individual user or group of users from whom to obtain rating information for presentation. This method of presentation may be altered by the user.

In embodiments, timelines may be selected for presentation to a user, or plurality of users, based at least in part on an algorithm used to measure a community's interest level in a given timeline or set of timelines. The community may be determined by a user or determined by a party other than the user.

In embodiments, timelines may be selected for presentation to a user, or plurality of users, based at least in part on an algorithm used to measure a relevance of a timeline to a user. For example, if more than one event is on the same time on the timeline, the relevance may be used to determine the order in which the events are to be displayed on the timeline.

In embodiments, events on the timeline may be provided with a hierarchical structure to indicate how one event is related to other events. The hierarchy of the events may be presented in a tree format; the tree format may be expanded or compressed to show more information or less information for a particular event.

Another method of adding information to the timeline may be performing a query of the datafeed generator 102 and selecting events from the search results to be added to the timeline. In an embodiment, the search results may be automatically added to the user's timeline or the user may select return results to be added to the timeline. For example, the user may perform a query on “presidential race” and have the search results automatically added to the timeline.

As previously described, a user may create one or more timelines. More than one timeline may be related to show relationships between events of the different timelines. The user may be able to edit the timelines, delete timelines, create additional timelines, or the like to maintain the set of timelines. A comparison tool may be provided to a user to enable the comparison of multiple timelines. The comparison of timelines may be between timelines created by a user, timelines created solely by parties other than the user, or a blend of user timelines and timelines created by others.

In an example, a gardener may chart the development of her tomato plants each year, recording the time of planting, germination, first leaf, weekly height, watering levels, date of first flowering, first fruit, and other data relating to tomato plant growth. The user may have ten consecutive years of such information which she would like to compare to see if there are differences in any of the salient data points, such as the length of time from planting to germination. In this example, the user learns by comparing the germination timelines that there has been a trend towards faster germination over the ten years covered by each of her annual timelines. She may now wish to compare her personal timelines to other timelines, such as the daily temperature chart for her area, or daily humidity/rainfall totals, or some other information of relevance to the growth of tomatoes. In this example, the gardener may learn that in her area there has been a marked increase in temperature on May 10^{th}, the day she plants her tomatoes each year, and many subsequent days over the course of the tomato season. She may then wish to compare her local temperature and moisture timelines to a national or global temperature and moisture timeline. Continuing the example further, after comparison of weather timelines indicating a trend towards global warming, the gardener may wish to view a timeline of her congressional representatives' voting histories on the “Global Warming Votes in Congress” timeline. Upon seeing a voting pattern indicative of representatives that do not believe global warming to be a threat, the gardener may select to view the timeline for the future congressional primaries and other electoral events relating to her district, and so forth.

In embodiments, timelines may be created on devices that are not connected to the Internet and these timelines may be uploaded following their creation upon a user reconnecting. Referring again to the gardener, she may find it convenient to record her tomato measurements on a handheld device, such as a PDA. As she takes her measurements she may record them locally to the PDA. Upon reconnecting to the Internet, for example to check her email or download contacts, the timeline data that she has stored locally on the PDA may be automatically uploaded. Alternatively, the upload could be a manual and/or selective upload of only specific data that the gardener seeks to add to the timeline. In the is way, the gardener may choose to add content to her timeline daily, or store the timeline data locally on her PDA for the entire growing season and only upload upon conclusion of the season.

The user may be able to share a timeline(s) with other users. Sharing may include exporting the timeline, exporting a selected set of events from the timeline, providing the timeline as an RSS feed, or the like. Sharing may also include allowing other users to input information into the timeline. For example, the user may give permissions to certain users or groups of uses to edit the timeline, maintain the timeline, add information to the timeline, add events to the timeline, or the like. The sharing of timelines with other users may provide for the set up of social networks using the timelines. As previously described, having access to another timeline may provide visibility to many aspects of the other user's life such as images, audio, video, and the like. In one example, if a friend had a baby, the user may be able to click on the event of the baby's birth and view pictures and video of the new baby and new family.

Continuing to refer to FIG. 1, there may be a number of viewing aspects of the timelines from the datafeed generator 102. The user requested timeline information may be published to a website 130 where the user may view the timeline(s) as previously described.

There may be a publishing API that may allow external sources to access the timeline API engine and create timelines for display on external pages such as webpages, documents, news sites, information sites, or the like. In an embodiment, access to the API may be free, may be on a fee basis, may be on a subscription, may be associated with advertising, or the like

In an embodiment, the timeline may be presented in a desktop widget 134. For example, when the user rolls over or clicks on an event a desktop widget 134 may be presented to give the user more information, links to more information, information on where to find more information, or the like. In a similar embodiment, the additional information may be presented in a webpage widget 138 and the webpage widget 138 may provide access to additional information on the web. A third party data site 128 may provide the information that is displayed in the webpage widget 138 and may contain the information, a link to the information, or the like.

In addition to the visual timeline on the timeline page, a text-only view may be provided a text based method of searching and data mining that parallels the timeline 302.

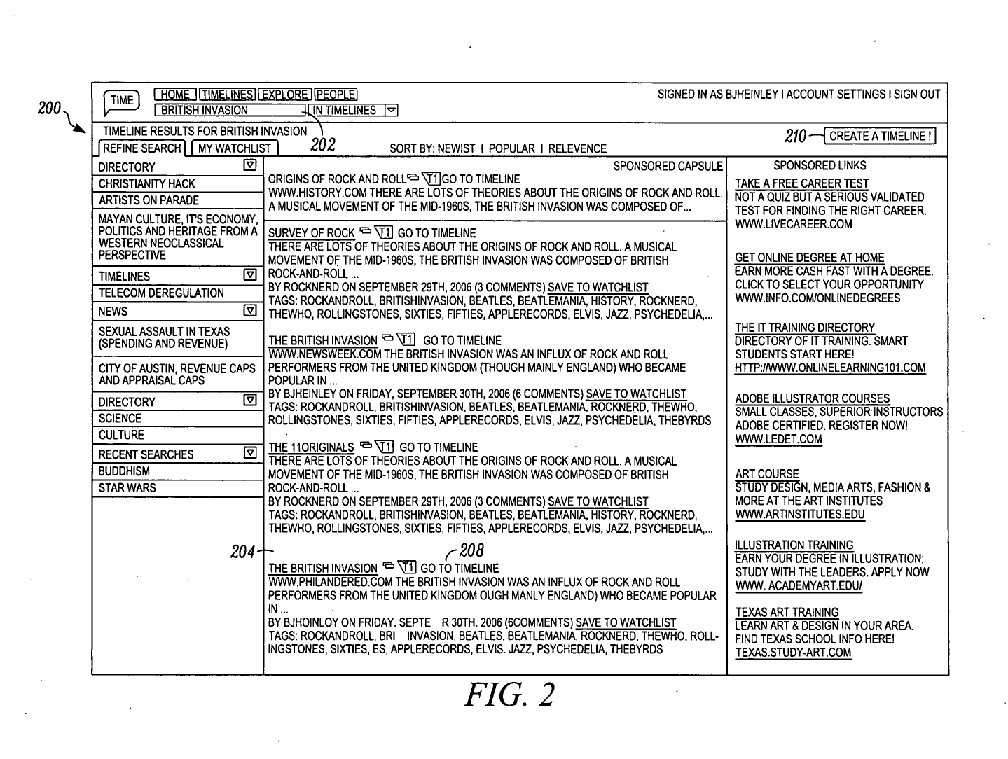

Referring now to FIG. 2, an embodiment of a datafeed generator 102 search results page 200 is shown. The user may input a query 202 into an input text box to find results that are related to the query 202. A set of search results 204 may be returned that may be individually 208 used for a timeline, or may be used to create a new 210 timeline. In an embodiment, selecting to create a new timeline 210 may automatically place all the search results 204 into the newly created timeline. In an embodiment, the search results may be sorted by the newest return, the most popular returns, the most relevant returns, or the like. The search results page may also provide sponsor links, paid advertisements, or the like.

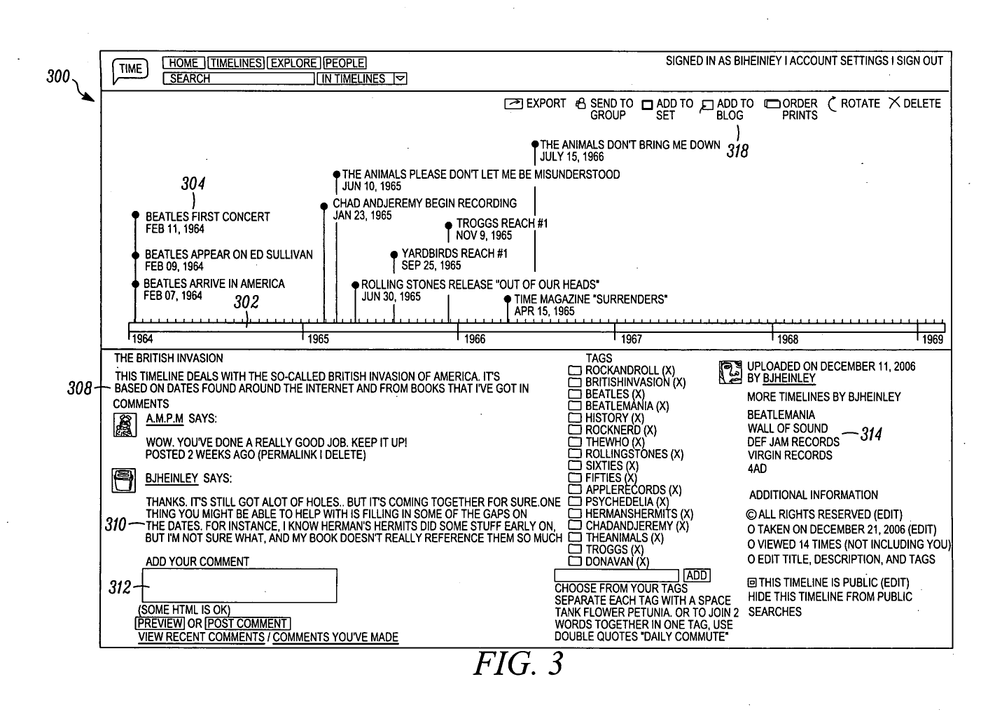

Referring to FIG. 3, an embodiment of a sample timeline page 300 is shown. In embodiments, the timeline page 300 may be a webpage, an application page, a desktop page, or the like. In an embodiment, a portion of the page may include the timeline 302, the events 304 of the timeline 302, and administrative actions 318, and the like, while another portion of the page may contain a user's commentary 308 on the timeline 302, other user comments 310 on the timeline, a comment box 312 of other users may provided comments to the user, links to other timelines, and the like. A user or plurality of users may be able to submit commentary relating to the specific events or other phenomena that are depicted on a timeline.

In an example, a user may present a personal timeline of a particularly memorable night out with friends. Among the many events depicted on the timeline may be their attendance at a concert. A second user who views the first user's timeline of their night out may submit commentary regarding the concert event that is depicted on the timeline. For example, the second user may have the set list of songs which were played in the concert. This commentary could be submitted in the form of a text listing of the set list of songs, a hyperlink to a set list maintained on the second user's website, or some other format. Alternatively, the set list commentary could itself be formatted as a timeline of the concert, in which the songs are temporally organized by their order of occurrence. The songs may also be temporally spaced along the timeline in a manner that corresponds with the length of each song. Such spacing may give knowledgeable users information that the band was, for example, perfunctorily and quickly making their way through their song catalogue (i.e., boring concert), or that they were playing extended versions of their songs, conversing with the crowd, or some other information that might be associated with longer songs and pauses between songs.

As previously described, the timeline 302 may be created manually by the user entering information from the user's personal store of information, or the timeline can be created by querying 202 the datafeed generator 102. In the example shown in FIG. 3, “The British Invasion” timeline may be a result of the query shown on FIG. 2 for the “British Invasion”. In this case, the timeline has a time frame for the years from 1964 through 1969 and the events 304 that may have been returned from the query 202 are shown on the timeline 302. As shown, the events 304 are shown as titles with indicators related to where they fall on the timeline 302. The user may be able to edit the timeline and events by changing the time frame displayed, selecting colors, selecting background skins, modifying event titles, modifying the timeline 302 title, and the like. In an embodiment, once the timeline 302 has been established, additional events may be added to the timeline 302 by manually adding information from the user's personal information store or by using a query 202 to find additional information from the datafeed generator 102.

The user may be able to add a commentary 308 to the timeline page 300 that may provide information on the origins of the timeline 302 information, comments on future information, and the like. Additionally, other users may be able to provide comments 310 on the information on the timeline 302. The timeline page 300 may also have links to other timelines 302 that may be the user's timelines 302, other timelines 302 on similar subjects, timelines from other users, or any other timeline 302 for which the user wishes to provide a link.

In an embodiment, the timeline page 300 may also contain administrative actions 318 such as exporting, sending the timeline to a group of users, adding the timeline 302 to another timeline 302, adding the timeline 302 to a blog, ordering prints of the timeline 302, rotating the orientation of the timeline 302, deleting the timeline 302, or the like. Additionally, the user may have a number of timeline 302 navigation tools such as forward/back over a timeline 302, zooming in/out to a timeline 302, displaying events 304, scaling the timeline 302 view, setting time ranges, setting convergences on/off, and the like.

By zooming in/out the user may be able to drill into details of the timelines 302. In an embodiment, the timeline 302 may present events based on the scale of the timeline 302. For example, with a scale of 1964 through 1967 the “British Invasion” timeline may only present the high point events of the “Invasion”. But if the user were to zoom into just one year, 1964 for example, more detail of that year may become available to the user. In the same manner, the user may be able to zoom into just one month of 1964 and view even more events. At any time, the user can zoom back to any time scale on the timeline 302.

Previously it was described that the user may assign a hierarchy to the different events 304 of a timeline 302. When displayed on the timeline page 300, common events for a same time may be presented using the assigned hierarchy. In an embodiment, in the timeline page 300, the user may be able to modify the events 304 hierarchy to reflect the user's desired organization for the displayed events 304.

In an embodiment, some timelines 302 may be dynamic, such as a personal timeline, where there are future events in the timeline 302. In an embodiment, each time the user views the timeline 302, the timeline may be presented in current time and the timeline may be reviewed to determine if any of the future events have become current. An event 304 that becomes a current event may initiate an action, such as a template, associated with the event 304. For example, the event 304 that becomes current may be a birthday and actions such as sending an email to friends to remind them to come to the party may be initiated.

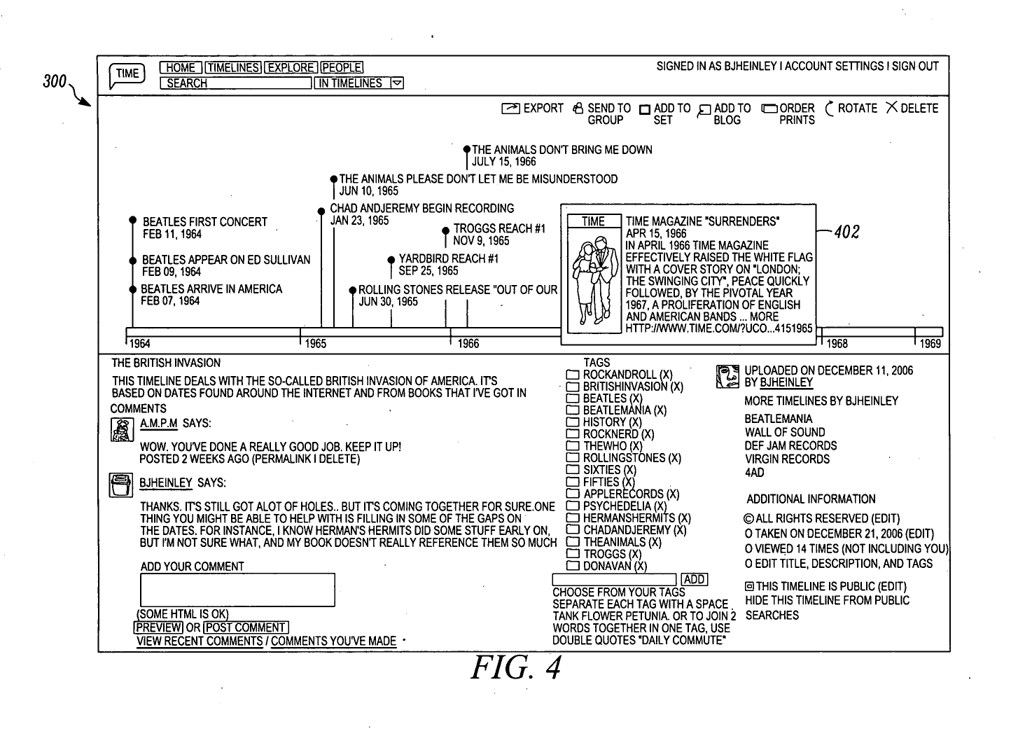

Referring to FIG. 4, an embodiment of the timeline page 300 with additional information 402 displayed is shown. In an embodiment, the timeline page 300 may contain additional information 402 such as images, audio, video, phone information, game information, location information, and the like. In FIG. 4, the additional information 402 shown is an image of a magazine cover that is associated with one of the events 304 of the timeline 302. In embodiments, the additional information 402 may be displayed by rolling the cursor over the event 304, clicking on the event 302, or some other indication that the user wishes to view the additional information 402. The additional information 402 may be displayed in a display window such as a popup window, a webpage, a desktop widget 134, a webpage widget 138, or the like. In an embodiment, there may be more than one additional information 402 associated with an event. When there is more than one additional information 402, the more than one additional information 402 may be displayed as a display window, popup window, widget, or the like and the user may select which of the additional information 402 to select to view additional information. In an embodiment, when the user selects one of the displayed additional information 402, the user may be redirected to the relevant data for the additional information 402. For example, if the additional data 402 is the magazine front page, the user may be redirected to the magazine website related to the image shown in the additional data 402. In another embodiment, the additional information 402 may be an image, audio file, video file, or the like, and selecting this type of additional information 402 may allow the viewing or playing of the image, audio, or video file.

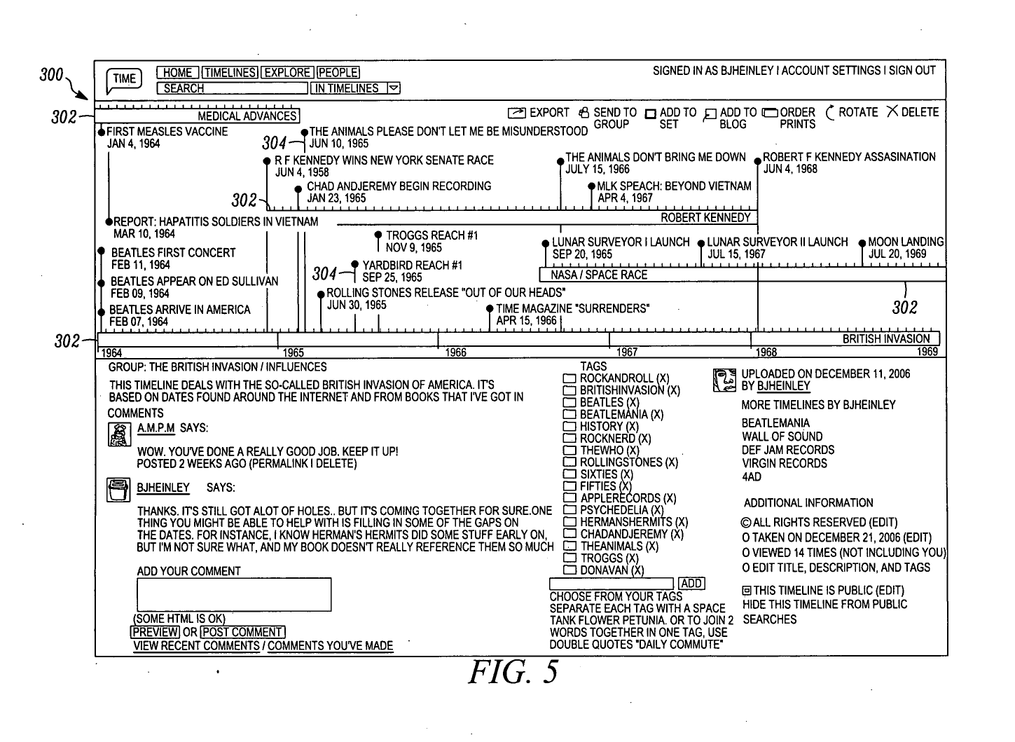

Referring to FIG. 5, an embodiment of multiple timelines 302 displayed on the timeline page 300 is shown. In an embodiment, the multiple timelines 302 may be displayed in relation to the time frames of the other timelines 302. For example, the timeline 302 and events 304 for the “Robert F. Kennedy” timeline is time related to the “British Invasion” timeline. In this manner, the user may be able to view the events of Robert Kennedy as they may compare to the events of the British Invasion. In an embodiment, when there are multiple timelines 302 open at once, the time line may be compressed or encapsulated into a single timeline 302. This may result in a single timeline that may show all of the events 304 of all the compressed timelines, show none of the events 304 until requested from the user, or the like. Once the timeline 302 has been compressed, the user may decompress the timeline 302 to restore the multiple timelines 302 as they were prior to compressing. In an embodiment, the user may be able to choose which compressed timelines 302 to decompress for viewing.

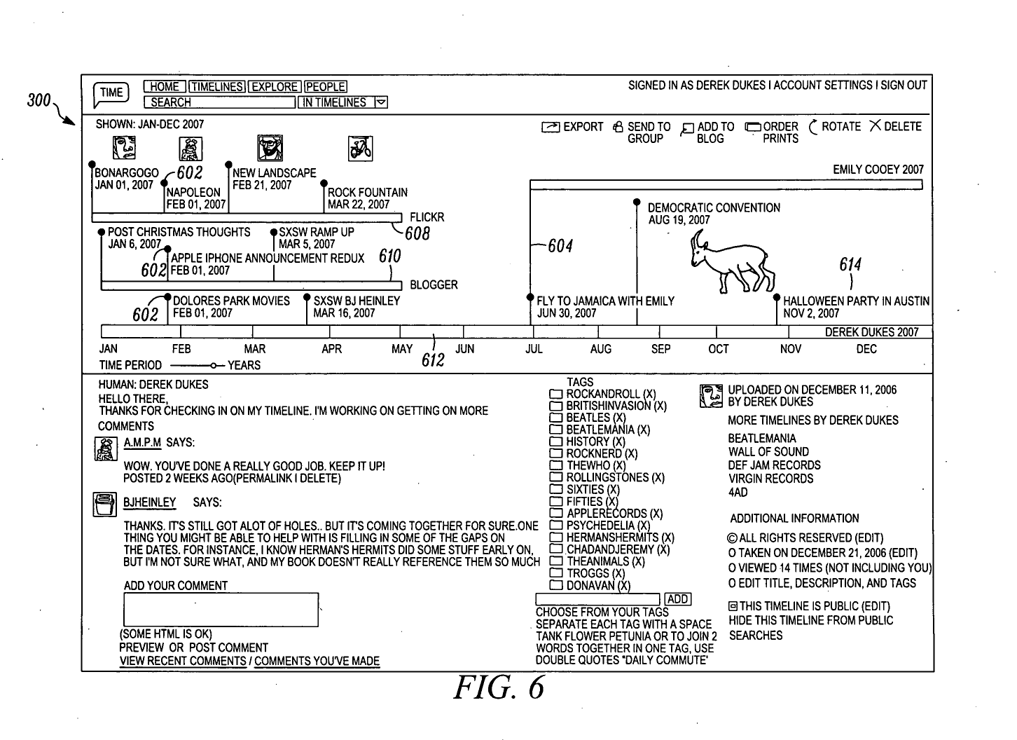

When viewing multiple timelines, convergences may be indicated for events that happened at the same time. The events do not need to be related to the same content, but just have occurred at the same time. The convergence may provide an easily identifiable indication of events that may be further explored by the user. Convergence will be further described in FIG. 6.

Referring to FIG. 6, an embodiment of timeline 302 event convergence (302, 304) is shown. A convergence may be when two or more events 304 occur at the same time for two or more different timelines 302. In an embodiment, the convergence (602 and 604) may be displayed as spanning across the more than one timeline 302, may be shown as a different color event 304, may be shown as a different color event indicator, or the like. As shown in FIG. 6, there is a convergence between the three timelines 302 for Feb. 1, 2007 shown as a red event indicator. The event indicator is shown as spanning across the three timelines 302 and as a different color. The convergence (602 and 604) may provide a quick visual indication that multiple events 304 have occurred on the same time frame. In this case, the convergence shows that the user posted a picture of his dog on flickr, posted a blog on the iPhone, and went to a show all on the same day. By viewing the convergence, the user may be able to easily view the activities of a particular time. This may be particularly useful when trying to remember information about an event or a day. The user can go back in time on the timeline 302 and the convergence indicator may automatically show the events that happened at the time of interest. In an embodiment, the convergence indication may be turned on or of

These timelines 302 also show the social networking capability of timelines 302. If the user allowed access to the timelines 302 to other users, the other uses would also be able to explore what may have happened on certain dates of the user's life. In addition to the three timelines shown here, another user's timeline(s) 302 may be added to this timeline page 300 to allow relationships between the different user's timelines 302 to be explored for information. As may be understood, there may be a plurality of other user timeline(s) 302 added to a single timeline page 300 to provide a full social network of timelines 302.

Similar to convergence, a view may be provided that allows the user to view a similar chain of events from different timelines that are centered at different time positions. For example, the user may have two timelines 302, one of the first Iraq war and one of the second Iraq war, and the user may be able to highlight similar events from each of the two wars, associate the similar events, or the like.

FIG. 6 shows examples of timelines from various datafeeds. There are timelines from a website (flickr) 608, a blog 610, and a personal timeline 612. In an embodiment, events 304 may have associated links to provide additional functionality such as the party 614 associated with an invitation website 614 Evite to allow the user to invite friends to the party.

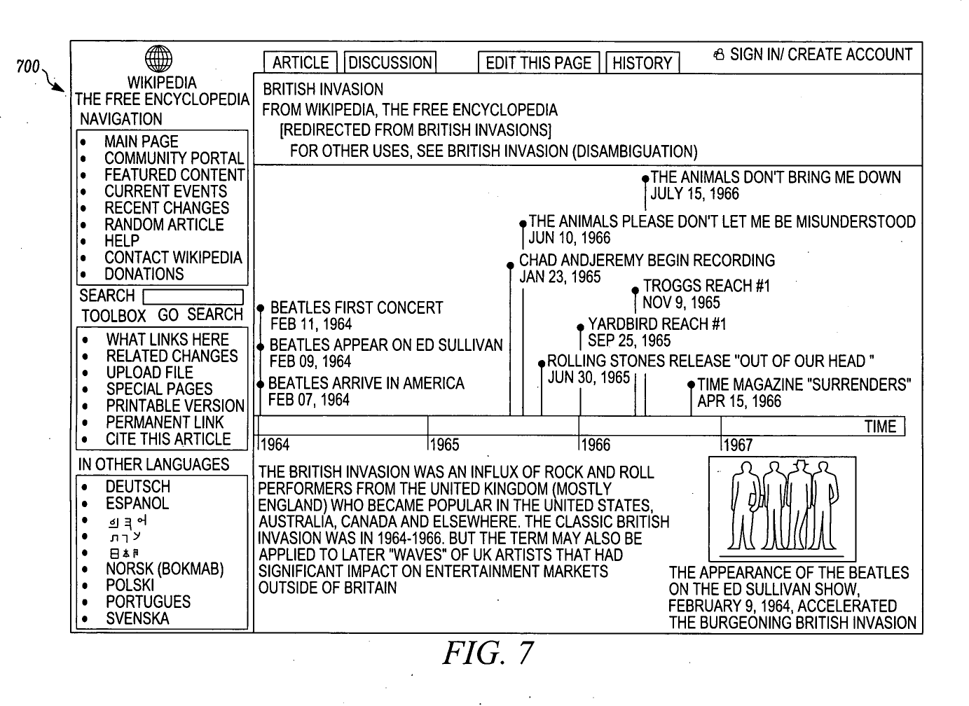

Referring to FIG. 7, an embodiment of a timeline 302 associated with public information page 700 is shown. Using the publishing API 132, commercial entities and other enterprises may be able to create timelines 302 to be associated with the commercial entities webpages, presentations, information packages, news broadcast, public information disclosures, and the like. As shown in FIG. 7, the timeline 302 for the “British Invasion” is incorporated into a Wikipedia page on the subject of the “British Invasion”. As shown, the timeline 302 may provide a visualization of many events within a single view. In an embodiment, the timeline 302 associated with the public information may be interactive by containing links to other related information in the same manner as the timelines 302 previously described. This may allow the user to click on the link and be redirected to additional information from the timeline 302.

The public information pages 700 may be applicable to many different domains such as celebrity-sponsored timelines, patents (e.g. invention timelines and filing timelines), entertainment, music, movies, sports, natural history, political history, personal timelines (e.g. journals, diaries, family histories), calendars, schedules, milestones, Gantt charts, photo histories (e.g. family, friends, girlfriends), inference engines (e.g. visual representations of time sequences), intersection points, ancestry, context advertising (e.g. advertisement for intersection points, topics, and convergences), timelines for search results, timelines as a product (e.g. search results), or the like.

For example, an enterprise may have a timeline 302 set to show the convergence of people going to car dealerships after a particular advertisement is shown. The enterprise may mark on one timeline when the advertisement ran and on other timelines 302 when people entered a dealership to discuss purchasing a car. In an embodiment, there may be a separate timeline for each dealership, and relationships of people entering to discuss a purchase and the purchase of the car can be associated to the advertisement on the original timeline 302.

In another example, timelines 302 may be developed for websites for entertainers, sport stars, people in public office, or the like. The timelines 302 may continually change as new events are added for the most recent events. In an embodiment, the copies of the timelines 302 may be sold. For example, the novelist William Faulkner is widely recognized for having, among other things, created a vibrant fictional “Yoknapatawpha County” in which he set many of his novels and characters. Readers of Faulkner may find a timeline or plurality of timelines a useful means of summarizing the many events occurring in Yoknapatawpha County and tracking the characters lives therein. In embodiments, fee-based access to such timelines may be provided to readers on a website, and profit-sharing arranged with Faulkner publishers to include the website address in the Faulkner books that they publish. Alternatively, such Faulkner timelines may be branded and published in book format alongside the text of a novel.

As understood by one skilled in the art, timelines 302 may be created by many different types of users for many different uses and may be combined, shared, worked on a group, or the like and are not limited by the provided examples.

In embodiments, timelines may be constructed based at least in part on fictional events. For example, the Star Wars movies, their plotlines, characters, events, and the like may be presented in a single timeline summarizing events, or alternatively may be summarized in a series of timelines, for example, with a timeline depicted for each character, movie scene, movie setting and so forth. Similarly, fictional events from novels, short stories, magazines, or any other source of fictional detail may be presented in a timeline.

In embodiments, timelines may be constructed based at least in part on hypothetical events. For example, historical “what ifs” may be summarized in a timeline depicting the events which may have occurred if a particular non-event had actually happened. For example, what if Castro's Cuban Revolution was unsuccessful? What if the development of the typewriter was delayed by 50 years? What if the atomic bomb was developed by Germany in 1914?

In another example, the construction of a hypothetical timeline may be a collaborative construction process that takes place within a social network. For example, a user may create a hypothetical timeline called “What if I Married Betty?” and grant access to contribute “events” to the timeline to persons (e.g., friends) selected by the user. Users that are provided access rights may then contribute events such as “had 13 children,” “divorced after 3 days,” “moved into trailer park down by the river,” or whatever suits the mood of the friends in the social network.

Users, both individual and commercial, may be able to write scripts to perform actions on a timeline created by another user. For example, the user may locate the timeline 302 on the “British Invasion” that may contain photos, video, and audio. The user may desire to present the timeline 302 information in a particular manner to another user or group. The script may be written to display the timeline 302 in the desired manner such as a certain time frame, using certain colors, showing a subset of events 304, or the like. In an embodiment, the script may be written in code or may be recorded and saved.

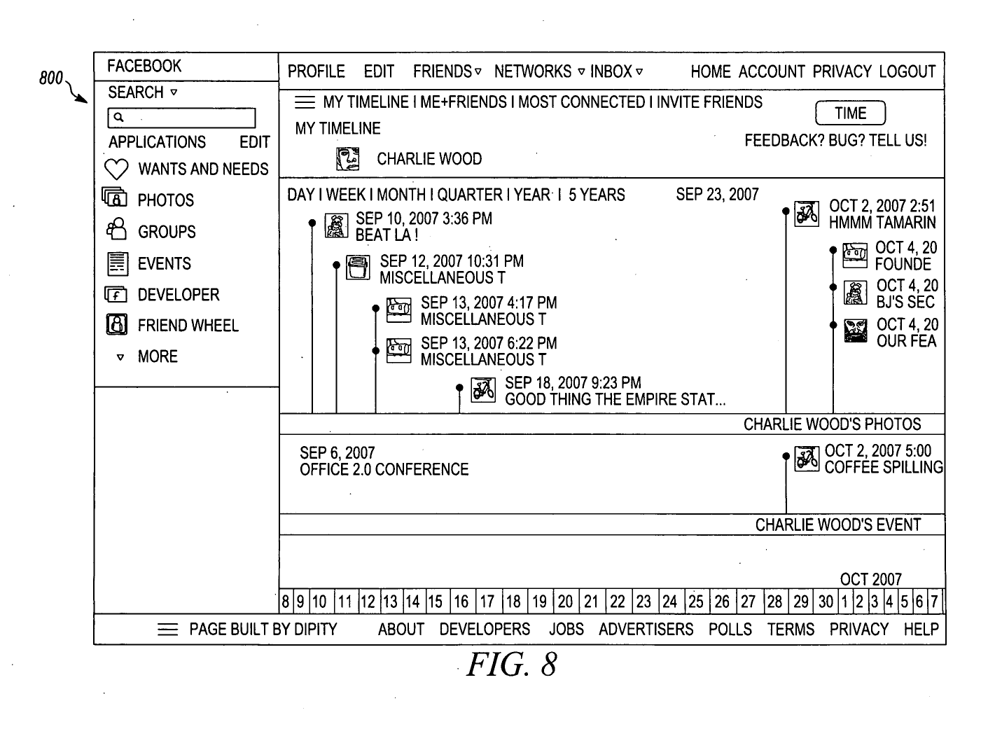

FIG. 8 shows a timeline for use in a social network. In general, a “friend” is another user in a social network who has invited the user to be a friend, or who the user has invited to be a friend, followed by a corresponding acceptance. The social network may provide a variety of tools for sharing information among friends and visualizing friends and relationships within a social network. The timeline may be automatically created when a user logs into a social networking application, based upon, e.g., time-based information of the user, time-based information of friends (as defined within the social network) of the user, and so forth. The timeline may employ specific events and/or objects identified by the user, or may display all time-based objects, or may employ one or more filters to selectively populate a timeline based upon user data.

The timeline may be a substantially linear representation of time, with an axis scaled according to hours, days, months, years, or any other units suitable for the displayed items. While a timeline typically employs a uniform scale, it will be understood that time may be compressed or expanded along portions of the timeline, and/or ellipses may be employed, as appropriate to accommodate the range and distribution of events to be illustrated on the timeline.

The timeline may be interactive. User controls for operations such as scrolling, zooming, jumping to a time, and so forth may be provided to permit navigation within the displayed timeline. Other user controls may provide for editing the timeline such as by adding annotations, adding events, inviting friends to an event, accepting invitations to an event, and more generally adding, removing, or editing other objects linked to the timeline. In one aspect, changes to the timeline may be used to update information for the user within the social network. Thus, for example, by graphically associating a picture with a time on the timeline, the picture may be uploaded to the user's social networking application account and tagged with a corresponding time. A user may also control rendering elements such as color, font, graphics for the timeline and/or object types associated therewith, background, and so forth. These visual elements may be encapsulated in themes that provide default selections for some or all of the available visual elements.

The timeline may be published or otherwise exported for use outside the social network so that, for example, the timeline may be incorporated into a web page or other network-accessible content. The exported timeline may include some or all of the interactive features provided by the source timeline. Access to the exported timeline may be credential-based so that only certain predetermined users (as determined according to credentials) can view some or all of the objects on the timeline.

In one aspect, a method disclosed herein includes automatic generation of a personal timeline from an existing data store of various object types within a social network. This may include any objects having time-based information, such as pictures, videos, events, and the like.

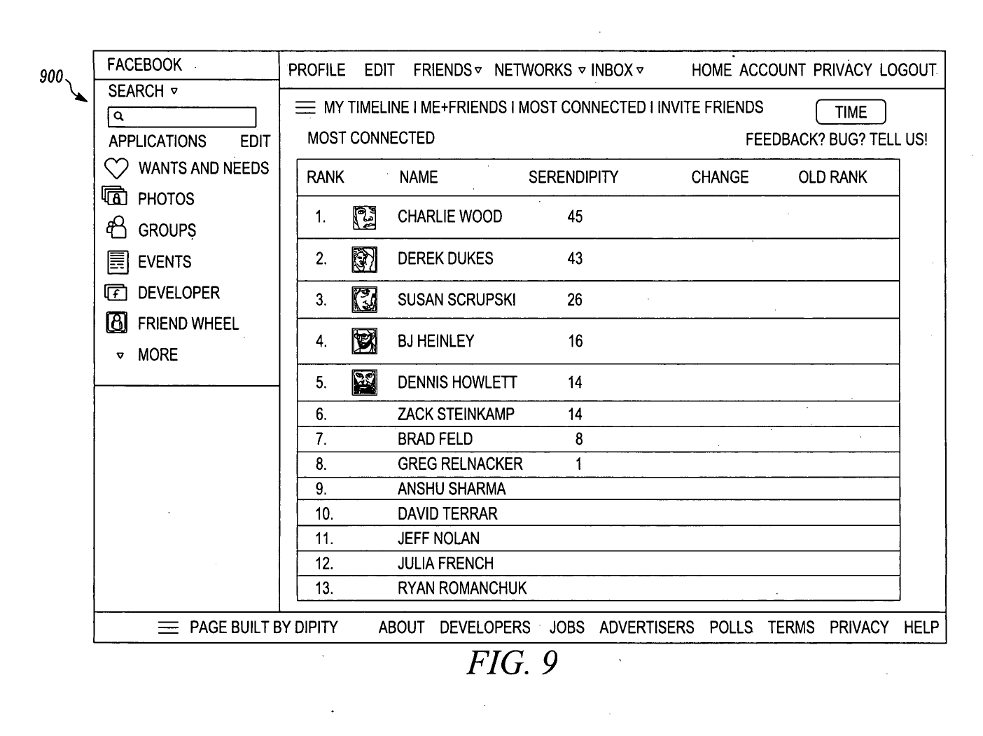

FIG. 9 shows common events shared by a number of users in a social network. In particular, friends may be ranked according to a number of common events shared with the user. This ranking may be based on a simple number of common events, or may be based on a score calculated using shared events along with any other weighting (e.g., for shared interests), filters (e.g., by region), and the like.

It will be understood that the nature of a user's association with an object may vary according to an object type. For example, for an event, a user may be associated with the event by attending the event. In this case, commonality may be determined by whether a friend attended or will attend the same event. As another example, for a picture or video, a user may be associated with the object by being in the picture/video as determined e.g. according to metadata associated therewith. In this case, commonality may be determined by whether a friend is also depicted within the same media. For a weblog, a user may be associated with the object by being a contributor, editor, or subscriber to the weblog. For a tag confirmation request, a user and friend may become associated through a request and confirmation of a metadata tag for another object. One or more of these associations may be employed to identify commonality with friends. The commonality may be calculated using the number of items in common, however, other calculations may also or instead be employed. For example, each shared item may be weighted according to the number of individuals associated therewith (e.g., number of people in a picture, number of people who attended an event), according to shared interests, location (e.g., address, city, or state), and/or according to other tag-based or profile-based information. Thus in one aspect, there is a method for objectively determining a connection with other users in a social network by determining a number of shared, time-based objects and calculating a score based upon the shared objects.

The system may also, or instead, show items that are not in common. In one aspect, the system may highlight events associated with friends that are not shared with the user. In this manner, a user may identify potentially shared events that the user is missing out on or has missed out on. Thus in one aspect, there is disclosed a method for objectively determining missed connections that includes determining one or more objects linked to friends that are not shared by a user. This may include weighting the objects according to a number of friends associated with the object. The missed connections may be ranked. The missed connections may also be filtered, such as by removing a bottom percentage of ranked, missed connections, or by showing only connections relating to a particular network of friends (e.g., a work network, a school network, a geographic network), or by limiting connections to a certain event type. The missed connections may be displayed on a separate timeline, in a ranked list, or as highlighted items in a merged view of timelines for a number of users.

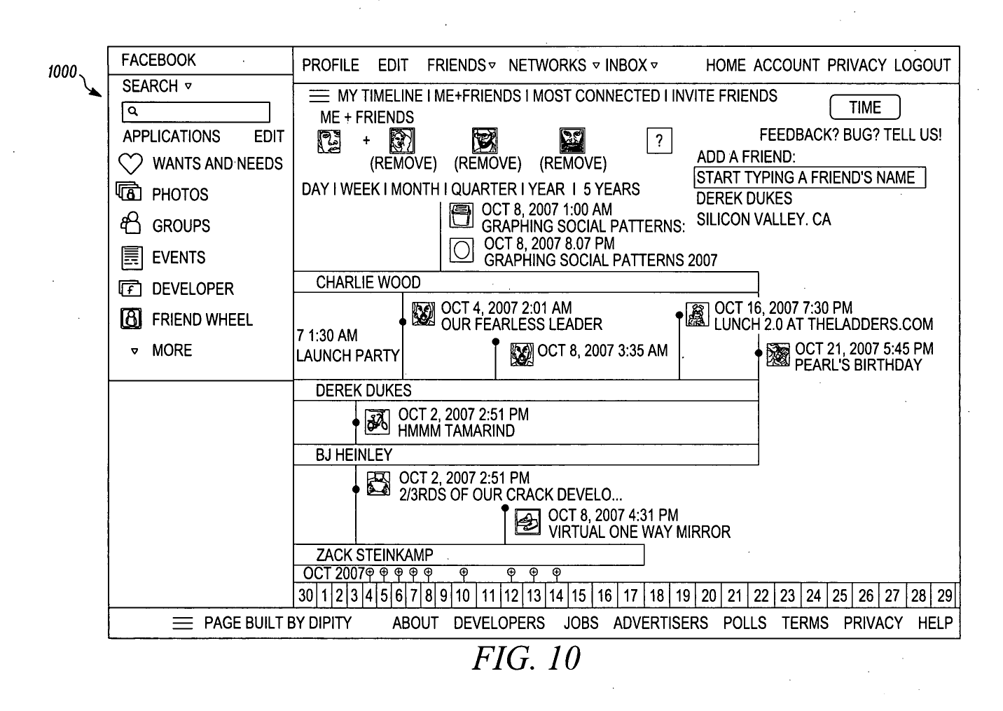

FIG. 10 shows a single view of timelines for a number of social network friends. In one aspect, a method disclosed herein includes displaying a composite timeline that combines a user's personal timeline with one or more other timelines of friends in the social network. These may be some or all of the user's friends, and may include specific friends selected by the user or friends selected according to user-provided criteria such as a shared interest, profession, region, or the like. In one aspect, the friends may be selected automatically based upon a number of events in common with the user. The display may graphically depict which events are shared by two or more individuals (friends and/or the user) using any suitable visualization including for example vertical lines, vertical dashed lines, color coding, annotations, or the like.

In one aspect, a user may select a number of friends (e.g., up to four) and have those friends' personal timelines depicted alongside the user's, for example vertically above or below the user's timeline and aligned temporally therewith. Other views may similarly be employed, such as a single composite timeline that identifies who is associated with each item using color coding or the like.

In embodiments, a user interface, as described herein, may enable a user to schedule an event to occur in the future. In an example, a user might specify scheduling an email, blog, online content post, twitter, or some other event.

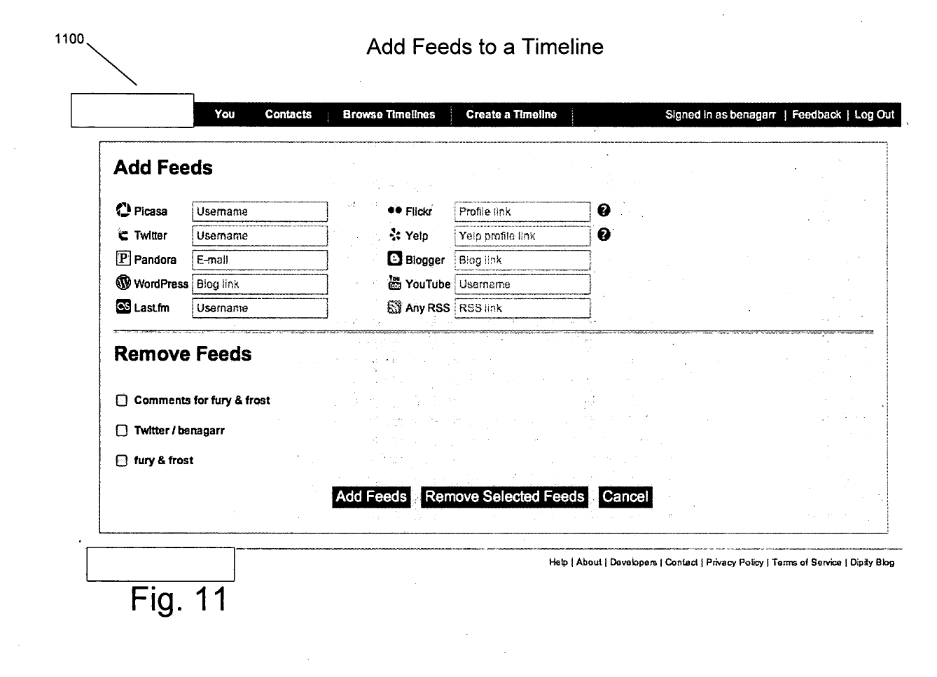

Referring to FIG. 11, the user interface, as described herein, may include a help screen within which the user may add feeds, remove feeds, or perform some other activity relating to the creation and management of timelines.

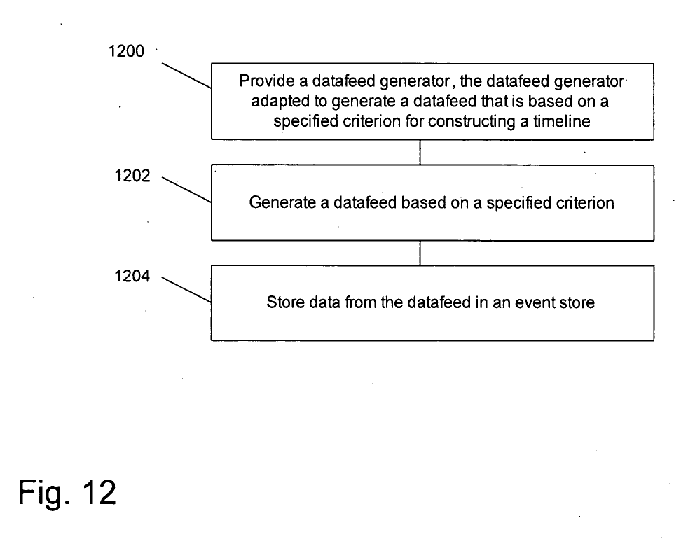

Referring to FIG. 12, in embodiments, a data feed generator may be provided that is adapted to generate a datafeed that is based on a specified criterion for constructing a timeline. A datafeed may be generated based on a specified criterion, and data from the datafeed may be stored in an event store. In embodiments, the datafeed generator may be associated with a user interface whereby a user may specify a user preference that is associated with a criterion. A criterion may be automatically generated and submitted to the datafeed generator based at least in part on a user behavior. A criterion may be a subject matter, a date, a keyword, a location, a demographic, a financial metric, or some other type of information. In embodiments, a user behavior may be a search query, a browse behavior, a transaction behavior, or some other type of user behavior.

In embodiments, an event store may be automatically updated based at least in part on a new datum within the datafeed. In embodiments, a datafeed may be a user-entered datum, an RSS feed, a spidered datum, a published datum, or some other type of datafeed.

In embodiments, a datafeed may be associated with social data.

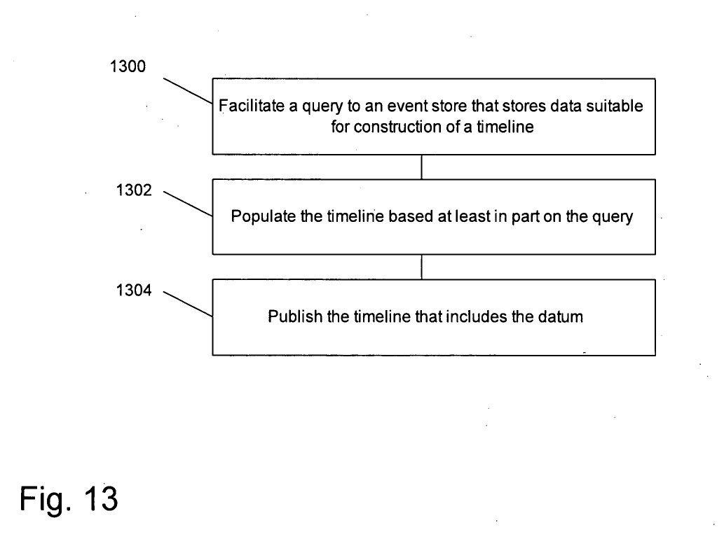

Referring to FIG. 13, in embodiments, a query may be made to an event store that stores data suitable for construction of a timeline. A timeline may be populated based at least in part on the query, and the timeline that includes the datum may be published.

In embodiments, a timeline may be populated based at least in part on a user-specified preference. In embodiments, a timeline may be populated based at least in part on a criterion developed based on user behavior.

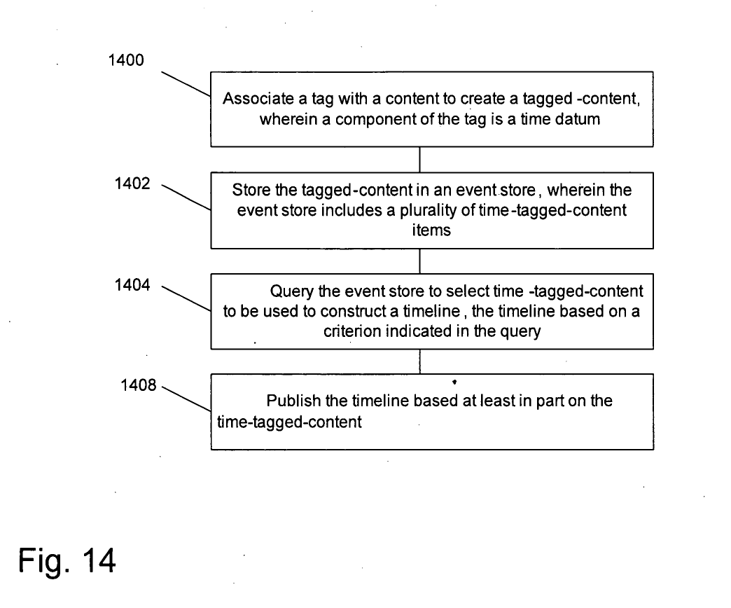

Referring to FIG. 14, in embodiments, a tag may be associated with a content to create a tagged-content, wherein a component of the tag is a time datum. The tagged-content may be stored in an event store, wherein the event store includes a plurality of time-tagged-content items. The event store may be queried to select time-tagged-content to be used to construct a timeline, the timeline based on a criterion indicated in the query, and the timeline based at least in part on the time-tagged-content may be published. In embodiments, the tagged content may be Internet content, user-created content, or some other type of content.

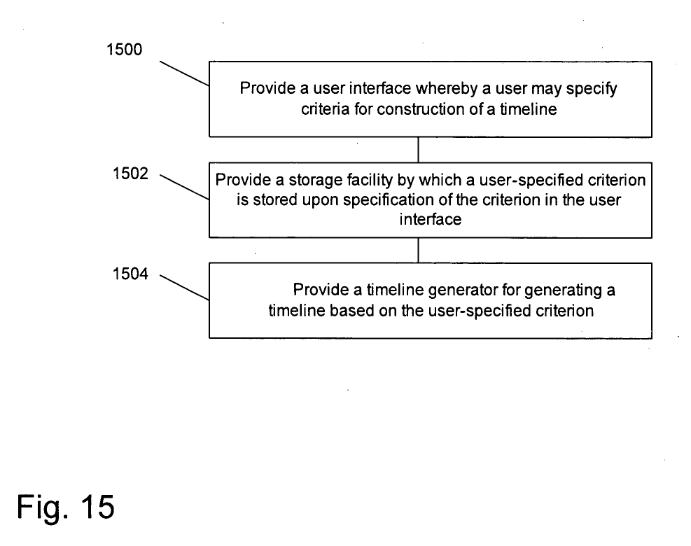

Referring to FIG. 15, in embodiments, a user interface may be provided whereby a user may specify criteria for construction of a timeline. A storage facility may be provided by which a user-specified criterion is stored upon specification of the criterion in the user interface, and a timeline generator may be provided for generating a timeline based on the user-specified criterion. In embodiments, the timeline generator may access an event store of time-tagged content items in order to populate the timeline. In embodiments, the user may specify a criterion that is a duration for the timeline.

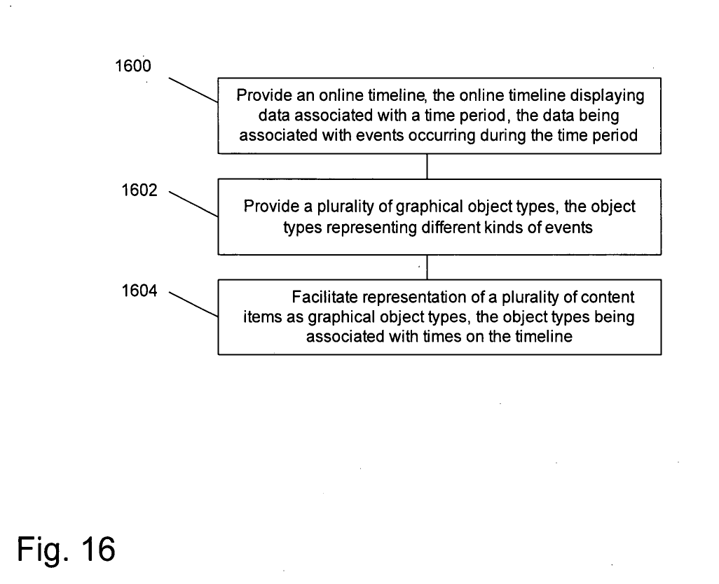

Referring to FIG. 16, in embodiments, an online timeline may be provided, the online timeline displaying data associated with a time period, the data being associated with events occurring during the time period. A plurality of graphical object types may be provided, the object types representing different kinds of events, and the representation of a plurality of content items as graphical object types may be enabled, the object types being associated with times on the timeline.

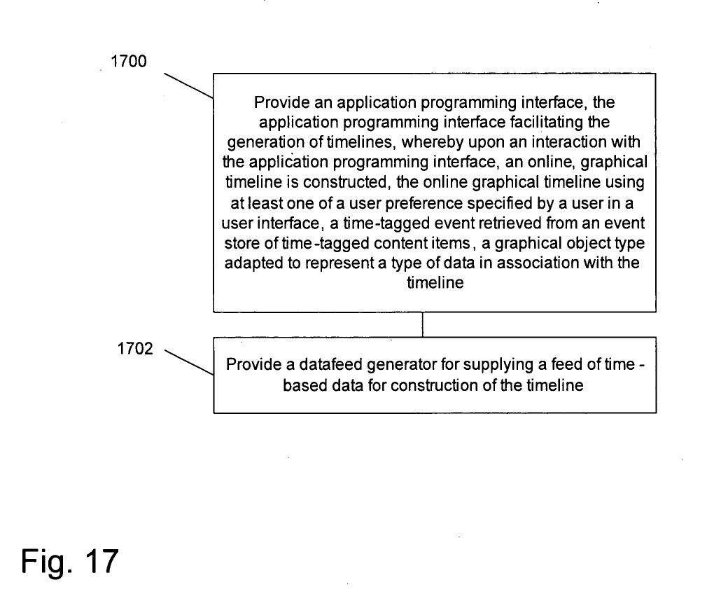

Referring to FIG. 17, in embodiments, an application programming interface may be provided, the application programming interface facilitating the generation of timelines, whereby upon an interaction with the application programming interface, an online, graphical timeline is constructed, the online graphical timeline using at least one of a user preference specified by a user in a user interface, a time-tagged event retrieved from an event store of time-tagged content items, a graphical object type adapted to represent a type of data in association with the timeline and a datafeed generator for supplying a feed of time-based data for construction of the timeline. In embodiments, the application programming interface may facilitate modification of the timeline by a plurality of users.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method comprising:
providing a datafeed generator, the datafeed generator adapted to generate a datafeed that is based on a specified criterion for constructing a timeline;
generating a datafeed based on a specified criterion; and
storing data from the datafeed in an event store.

2. The method of claim 1, wherein the datafeed generator is associated with a user interface whereby a user may specify a user preference associated with the criterion.

3. The method of claim 1, wherein the criterion is automatically generated and submitted to the datafeed generator based at least in part on a user behavior.

4-6. (canceled)

7. The method of claim 1, further comprising automatically updating the event store based at least in part on a new datum within the datafeed.

8. The method of claim 1, wherein the datafeed is a user-entered datum.

9. The method of claim 1, wherein the datafeed is an RSS feed.

10. The method of claim 1, wherein the datafeed is a spidered datum.

11. The method of claim 1, wherein the datafeed is a published datum.

12. The method of claim 1, wherein the datafeed is a published datum.

13. The method of claim 1, wherein the specified criterion is a subject matter.

14. The method of claim 1, wherein the specified criterion is a date.

15. The method of claim 1, wherein the specified criterion is a keyword.

16. The method of claim 1, wherein the specified criterion is a location.

17. The method of claim 1, wherein the specified criterion is a demographic.

18. The method of claim 1, wherein the specified criterion is a financial metric.

19. The method of claim 1, wherein the datafeed generator is further associated with social data.

20. A method comprising:
facilitating a query to an event store that stores data suitable for construction of a timeline;
populating the timeline based at least in part on the query; and
publishing the timeline that includes the datum.

21. The method of claim 20, wherein the timeline is populated based at least in part on a user-specified preference.

22. The method of claim 20, wherein the timeline is populated based at least in part on a criterion developed based on user behavior.

23. A method comprising:
associating a tag with a content to create a tagged-content, wherein a component of the tag is a time datum;
storing the tagged-content in an event store, wherein the event store includes a plurality of time-tagged-content items;
querying the event store to select time-tagged-content to be used to construct a timeline, the timeline based on a criterion indicated in the query; and
publishing the timeline based at least in part on the time-tagged-content.

24. The method of claim 23, wherein the tagged-content is an Internet content.

25. The method of claim 23, wherein the tagged-content is a user-created content.

26. A method, comprising:
providing a user interface whereby a user may specify criteria for construction of a timeline;
providing a storage facility by which a user-specified criterion is stored upon specification of the criterion in the user interface; and
providing a timeline generator for generating a timeline based on the user-specified criterion.

27. The method of claim 26, wherein the timeline generator accesses an event store of time-tagged content items in order to populate the timeline.

28. The method of claim 26, herein the user specified criterion specifies a duration for the timeline.

29. A method, comprising:
providing an online timeline, the online timeline displaying data associated with a time period, the data being associated with events occurring during the time period;
providing a plurality of graphical object types, the object types representing different kinds of events; and
facilitating representation of a plurality of content items as graphical object types, the object types being associated with times on the timeline.

30. A method, comprising:
providing an application programming interface, the application programming interface facilitating the generation of timelines, whereby upon an interaction with the application programming interface, an online, graphical timeline is constructed, the online graphical timeline using at least one of a user preference specified by a user in a user interface, a time-tagged event retrieved from an event store of time-tagged content items, a graphical object type adapted to represent a type of data in association with the timeline and a datafeed generator for supplying a feed of time-based data for construction of the timeline.

31. The method of claim 30, wherein the application programming interface facilitates modification of the timeline by a plurality of users.
